(19) United States
(12) Patent Application Publication
(10) Pub. No.: US 2026/0168836 A1
(43) Pub. Date: Jun. 18, 2026

(54) METHOD FOR CHECKING AN AUTOMATION TECHNOLOGY FIELD DEVICE DURING OPERATION, AND CORRESPONDING FIELD DEVICE

(71) Applicant: Endress+Hauser Flowtec AG, Reinach (CH)

(72) Inventors: Bernhard Koch, Bad Säckingen (DE); Robert Lalla, Lörrach (DE); Christoph Meyer, Birsfelden (CH); Dieter Schweizer, Bubendorf (CH)

(21) Appl. No.: 19/134,437

(22) PCT Filed: Nov. 16, 2023
(86) PCT No.: PCT/EP2023/081998

§ 371 Date: May 30, 2025

(30) Foreign Application Priority Data
Dec. 9, 2022 (DE) 10 2022 132 794.9

(51) Int. Cl. G01F 1/84

(52) U.S. Cl. CPC G01F 1/8431; G01F 1/8436

(57) ABSTRACT

A method for online checking an automation technology field device that has a sensor unit and a control/evaluation unit and that determines a process variable of a medium based on at least two sensor signals includes transferring a first sensor signal to a first measuring channel having a first preprocessing block and transferring a second sensor signal to a second measuring channel having a second preprocessing block. The first sensor signal and the second sensor signal are connected in parallel to a verification channel having a third preprocessing block. The third preprocessing block is, during the time period of parallel connection of the first sensor signal, configured identically to the first preprocessing block and, during the time period of parallel connection of the second sensor signal, configured identically to the second preprocessing block. The output signals of the first, second, and third preprocessing blocks are compared.

The invention relates to a method for online checking an automation technology field device. In the context of the present invention, online checking the field device means checking without interrupting the normal measuring or control operation of the field device. Neither the acquisition of the measurement or control data nor the processing or preparation of the measurement signals is interrupted.

A wide variety of field devices have become known from the prior art and are used in industrial automation systems-both in process automation and in manufacturing automation. In conjunction with the invention, field devices are considered to be all devices which are process-oriented and which provide or process process-relevant information. Field devices record and/or influence-depending on the field of application-physical, chemical or biological process variables of at least one process medium.

Measuring devices consisting of at least one sensor unit—also known as a measuring sensor—and a transducer unit are used to record process variables of a medium. Each sensor unit provides analog measured values, which are usually digitally processed in one or more measuring channels of the transducer unit. In this context, reference is usually made to a preprocessing of the measured values. So-called raw measured values are available at the output of the measuring channels and are further processed by a computing unit to produce the actual process variable. For example, if the measuring devices are for measuring pressure and temperature, conductivity, flow, pH or fill level, the measuring device provides information about the determined process variables: pressure, temperature, conductivity, flow, pH or fill level of a medium in a container. The Endress+Hauser Group develops, produces and distributes a large variety of such measuring devices.

Actuators, such as valves or pumps, are used for influencing the process variables by which, for example, the flow rate of a liquid in a pipe or the fill level in a container is controlled or monitored.

Without limiting the focus of the method according to the invention or the corresponding device, reference is made below to the prior art in the field of measuring devices, in particular flow devices. The flow measurement of flowing media is based on different measuring principles, wherein the choice of the measuring device or measuring principle ultimately used often depends on the respective application.

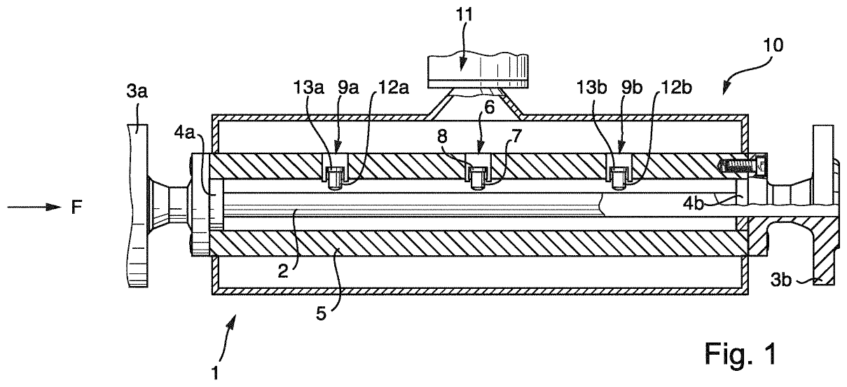

Endress+Hauser offers flowmeters based on five different measuring principles that determine either the mass flow or the volume flow of a medium. Coriolis flowmeters are capable of determining the mass flow of a medium through a pipeline with high accuracy. Alternatively or additionally, they provide information about the density or viscosity of the flowing medium. A variant of a Coriolis flowmeter- or more precisely-a variant of the sensor unit of a Coriolis flowmeter is described in more detail in FIG. 1. A flowmeter based on the ultrasonic transit time principle is described, for example, in the international patent application WO 2014/001027 A1. A flowmeter operating according to the thermal measuring method is shown, for example, in the international patent application WO 2014139786 A1. Measuring devices based on the vortex measuring principle and the magnetic-inductive measuring principle have also become well known in the prior art in a wide variety of designs.

Depending on the design of the automation system or the location, the pipe section in which the flow is to be determined can be a closed pipeline, a section of an open pipe or a body of water. All flowable media can be used as process media.

Measuring devices are often used in safety-critical applications, which requires that both the hardware and software components function correctly and without errors. In order to meet this requirement, the functionality of the measuring device must be subjected to constant monitoring with regard to both analog and digital signal processing. For example, diagnostic measures are carried out to detect random hardware defects. It goes without saying that the measuring or control operation of a field device, especially in a safety-critical application, must not be interrupted during the checking process. But this constant checking of analog or digital signal paths is not only required in safety-critical applications. Rather, users generally expect that the installed base of field devices in their automation system works correctly and that malfunctions, especially in the development process, are detected and corrected promptly. This is the only way to effectively prevent the failure of a field device and any resulting downtime of the automation system.

DE 10 2005 025 354 A1 discloses a Coriolis flowmeter in which analogue measuring signals are superimposed with an auxiliary signal of known frequency and waveform for the purpose of functional checking. The auxiliary signal is then completely separated from the actual measurement signals in the digital processing and used to check the plausibility of the correct function of the measuring channels. The known checking procedure is not designed for a highly precise—i.e., bit-true and/or cycle-accurate-checking of the digital part of a measuring channel.

Furthermore, it has become known to design the preprocessing blocks of each measuring channel redundantly—i.e., twice. This checking method requires a doubling of the digital circuitry, which also results in increased power consumption.

Another well-known checking method involves feeding a test pattern to the measuring channel to be checked via a multiplexer. This method allows the correct function of the digital preprocessing blocks of the measuring channels to be checked in a bit-true or cycle-accurate manner. The disadvantage of this method is that the signal paths must be interrupted during the checking process. As already mentioned, this is not acceptable in many use cases. For example, even a short interruption in a Coriolis flowmeter leads to a disruption of the frequency and amplitude control and consequently also to a disruption in the provision of the measured values.

The object of the invention is that of providing a method for the highly accurate online checking of at least one digital measuring channel of an automation technology field device.

The object is achieved by a method for (online) checking a field device for determining and/or monitoring at least one process variable of a medium, wherein the field device has a sensor unit and a control/evaluation unit with a first measuring channel formed by means of an, in particular configurable, first preprocessing block, with a second measuring channel formed by means of an, in particular configurable, second preprocessing block and with a verification channel formed by means of a configurable (verifying) third preprocessing block, in which method:
the sensor unit generates a first sensor signal dependent on the at least one process variable and the first sensor signal is transmitted to the first measuring channel
and simultaneously therewith the sensor unit generates a second sensor signal dependent on the at least one process variable and the second sensor signal is transmitted to the second measuring channel;
wherein the first sensor signal in the first measuring channel is converted into a first digitalized sensor signal and the first digitalized sensor signal is transmitted to the first preprocessing block and simultaneously the second sensor signal in the second measuring channel is converted into a second digitalized sensor signal and the second digitalized sensor signal is converted and transmitted to the second preprocessing block;
wherein the first digitalized sensor signal is transmitted to the verification channel for a predetermined (first) period of time—for example, namely a period of time during which the third preprocessing block is configured identically to the first preprocessing block- and is converted into a (digital) output signal of the third preprocessing block that is dependent on the first digitalized sensor signal, and said output signal is compared with the output signal of the first preprocessing block, for example, in a bit-true manner, for example, namely, synchronized in a cycle-accurate manner and compared in a bit-true manner;
and wherein the second digitalized sensor signal is transmitted to the verification channel for a predetermined (second) period of time—for example, namely a period of time during which the preprocessing block is configured identically to the second preprocessing block- and is converted into a (digital) output signal of the third preprocessing block that is dependent on the second digitalized sensor signal, and said output signal is compared with the output signal of the second preprocessing block, for example, in a bit-true manner or bit-by-bit, for example, namely, synchronized in a cycle-accurate manner and compared in a bit-true manner.

Alternatively or in addition, the object is achieved by a method for online checking of an automation technology field device, wherein the field device has a sensor unit and a control/evaluation unit, and wherein the field device determines or monitors at least one process variable of a medium based on at least two sensor signals,
wherein the first sensor signal is transmitted in a first measuring channel to a configurable first preprocessing block,
wherein the second sensor signal is transmitted in a second measuring channel to a configurable second preprocessing block,
wherein the first sensor signal and the second sensor signal are successively connected in parallel for a predetermined period of time to a verification channel with a configurable (verifying) third preprocessing block,
wherein the (verifying) third preprocessing block is, during the time period of parallel connection of the first digital sensor signal, configured identically to the first preprocessing block,
wherein the (verifying) third preprocessing block is, during the time period of parallel connection of the second digital sensor signal, configured identically to the second preprocessing block, and
wherein the output signals of the (verifying) third preprocessing block are successively synchronized with the output signals of the first preprocessing block and the output signals of the second preprocessing block by means of a synchronization unit and compared in a bit-true manner. As already mentioned, the field device can also be an actuator.

The term “online checking the field device” in conjunction with the invention means that the checking is carried out during the regular measuring operation of the field device: The regular measuring operation is neither interrupted nor disturbed by the checking process. Due to the cycle-accurate synchronization of the output signals of the verifying preprocessing block and the particular preprocessing block being checked, the output signals of the verification channel can be checked in a bit-true manner using each of the preprocessing blocks in the x measuring channels (with x>1).

According to a development of the method according to the invention, it is provided that an error message is generated if the output signals of the first preprocessing block or the output signals of the second preprocessing block and the output signals of the (verifying) third preprocessing block show a deviation. Preferably, an error message is only issued when the deviation manifests itself in at least two consecutive measuring cycles.

Furthermore, in conjunction with the method according to the invention, it is provided that the online checking of the at least two measuring channels is carried out cyclically or acyclically.

A development of the method according to the invention proposes that the following method steps are carried out for the purpose of cycle-accurate synchronization of the output signals of the (verifying) third preprocessing block with the output signals of the preprocessing block to be checked:
the preprocessing block of a measuring channel to be checked continuously provides output signals at a defined time interval and signals the provision of the output signal with a ready pulse,
after the verifying preprocessing block is configured identically to the preprocessing block to be checked, the synchronization unit receives a command pulse from the control/evaluation unit at any time,
upon receipt of the following ready pulse of the preprocessing block to be checked, the synchronization unit sends a reset pulse (r) to the (verifying) third preprocessing block after a defined waiting time (τ), wherein the waiting time (τ) is dimensioned such that the output signals of the (verifying) third preprocessing block and the output signals of the preprocessing block to be checked are synchronized in a cycle-accurate manner.

It is considered advantageous in conjunction with the invention if the waiting time τ is determined using the following equation:

$$τ = n - ( m mod n ) ,$$

wherein m specifies a time period that is known for the preprocessing block to be checked and consequently for the (verifying) third preprocessing block—due to the identical calibration. m does not necessarily have to be >n, but usually will be. The number m indicates how many time units/cycles the processing block needs after a reset until the first valid result value is available. This is due to the settling time of the preprocessing block after a reset. In a typical/real-life scenario, m is 3*n+7, i.e. 3 processing cycles including settling time, plus a total of 7 time units/clock cycles overhead to complete the reset process and generate a ready pulse.

For example, the field device generates at least two analog sensor signals to determine or monitor the process variable of a medium, which sensor signals are digitalized and preprocessed in the associated measuring channels. The field device can be, for example, a Coriolis flowmeter that determines the mass flow, density and/or viscosity of a medium flowing through a pipeline. The mass flow can be determined or monitored continuously based on the phase difference that occurs between the first sensor signal and the second sensor signal.

Furthermore, the invention further consists in an automation technology field device, for example a Coriolis flowmeter, set up to carry out one of the methods according to the invention, wherein an A/D converter is provided in each of the first and second measuring channels, followed by the respective preprocessing block,
wherein a switching element is provided, via which the digital output signals of the A/D converters can be switched, for example successively, to the input of the (verifying) third preprocessing block for the predetermined (first or second) time period,
wherein a synchronization unit is provided which is configured to control the (verifying) third preprocessing block such that the output signals of the (verifying) third preprocessing block and the output signals of the preprocessing block to be checked are synchronized, in particular in a cycle-accurate manner, and
wherein the control/evaluation unit is configured to determine, by comparing the synchronized output signals of the preprocessing block to be checked and the (verifying) third preprocessing block, whether the preprocessing block checked is operating correctly.

According to a further embodiment of the invention, it is provided that the third preprocessing block is (re-)configurable. In further developing this embodiment of the invention, it is further provided that the third preprocessing block is configured in the same way as, for example identically to, the first preprocessing block during the first time period, for example not identically to the second preprocessing block, and/or that the third preprocessing block is configured in the same way as, for example identically to, the second preprocessing block during the second time period, for example is not configured identically to the first preprocessing block. Alternatively or in addition, the first preprocessing block and/or the second preprocessing block can also be (re-)configurable, for example.

According to a further embodiment of the invention, the measuring channels have identical hardware. In addition, the preprocessing blocks of the measuring channels and the verifying preprocessing block can have identical hardware structures.

According to a development, the A/D converters in the first measuring channel and in the at least one further measuring channel are sigma-delta converters.

The following embodiments of the field device according to the invention relate to the preprocessing blocks. These can be designed in such a way that they provide low-pass filtered digital signals of the analog sensor signals of the measuring sensor as output signals. Alternatively, they provide digital signals as output signals that correspond to statistical parameters, such as min/max values or standard deviations, of the analog sensor signals. According to a third variant, the preprocessing blocks are designed in such a way that they provide digital signals as output signals that represent components of the analog sensor signals separated by frequencies.

The invention is explained in greater detail with reference to the following figures. in which:

FIG. 1: shows a longitudinal section through a Coriolis flowmeter with a straight measuring tube, as known from the prior art,

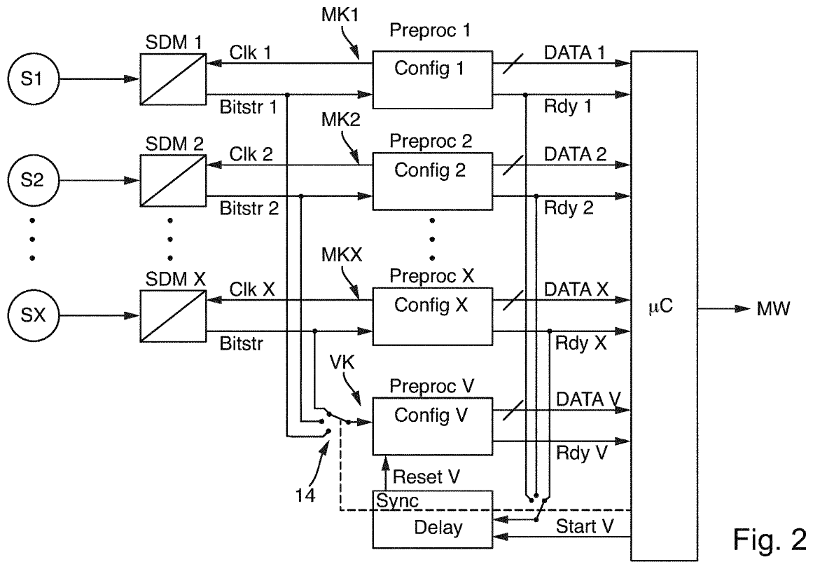

FIG. 2: shows a block diagram of an embodiment of the components relating to the invention of a transducer unit of a measuring device with x measuring channels,

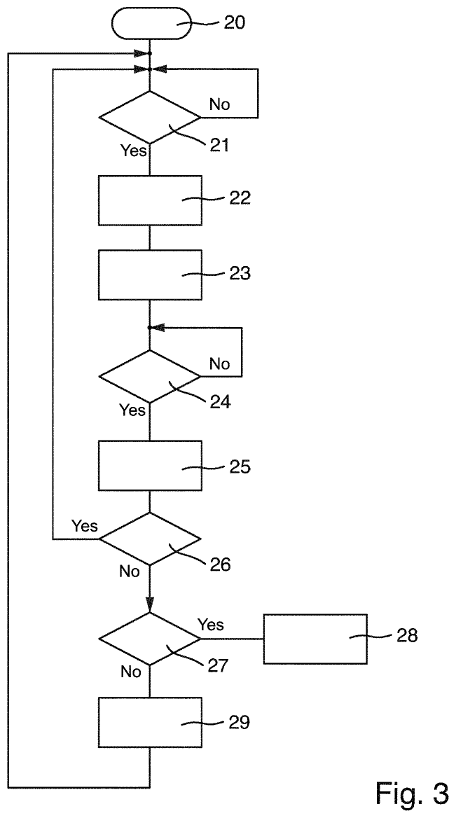

FIG. 3: shows a flowchart of an embodiment of the method according to the invention, and

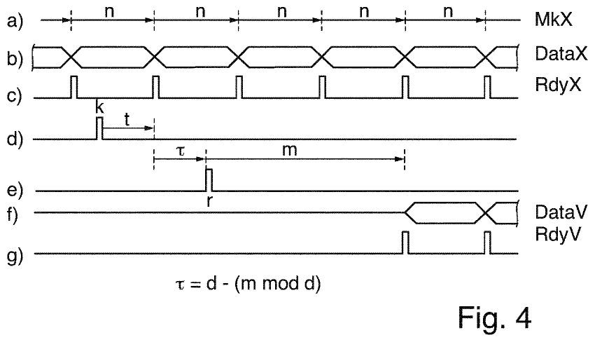

FIG. 4: shows a representation of the signal curves for the purpose of cycle-accurate synchronization of the output signals of the verifying preprocessing block and the preprocessing block to be checked.

FIG. 1 shows a longitudinal section through a Coriolis flowmeter 1 with a sensor unit or a measuring sensor 10 and a control/evaluation unit or a transducer unit 11 in a schematic representation. The housing with the control/evaluation unit 11 can be attached to the sensor unit 10—as shown here—but it can also be arranged separately from the sensor unit 10. The sensor unit 10 is mounted via flanges 3a, 3b in a pipeline not shown separately. The pipeline as well as the aligned measuring tube 2 are passed through by a fluid medium F, the mass flow of which is to be determined. The flow direction of the fluid medium F is indicated by the arrow.

In the case shown, the measuring tube 2 is designed as a straight measuring tube 2, which is fixed on the inlet and outlet sides via an end plate 4a, 4b to the flange 3a and the flange 3b, respectively. The flanges 3a, 3b and the end plates 4a, 4b are attached to or in a support tube 5. A variety of other designs of Coriolis flowmeters with at least one measuring tube have become known from the prior art. Examples of sensors to be mentioned are those with a measuring tube with cantilever mass, as described, for example, in EP 97 81 0559, measuring sensors with a curved measuring tube (EP 96 10 9242), measuring sensors with two parallel straight or curved measuring tubes (U.S. Pat. No. 4,793,191 or 4,127,028) or measuring sensors with four curved measuring tubes.

In order to be able to use the Coriolis effect to determine the mass flow of a medium through the measuring tube 2, the measuring tube 2 is set into bending vibrations by a centrally arranged vibration exciter 6. These bending vibrations occur in the plane of the drawing. The vibration exciter 6 can be, for example, an electromagnetic drive consisting of a permanent magnet 7 and a coil 8. The coil 8 is fixed to the support tube 5 and the permanent magnet 7 to the measuring tube 2. The amplitude and frequency of the bending vibrations of the measuring tube 2 can be controlled via the current flowing in the coil 8. The Coriolis forces acting on the flowing medium in the plane of the drawing cause a phase shift of the vibrations of the measuring tube which is dependent on the mass flow and which is measured by means of the two vibration sensors 9a, 9b.

The two vibration sensors 9a, 9b are also arranged symmetrically to the vibration exciter 6 on the support tube 5. The vibration sensors 9a, 9b can be, for example, electromagnetic transducers, each consisting of a permanent magnet 12a, 12b and a coil 13a, 13b, the arrangement of which can be analogous to the permanent-magnet-coil arrangement of the vibration exciter 6: The two permanent magnets 12a, 12b are fixed to the measuring tube 2 and the two coils 13a, 13b to the support tube 5. The oscillating movement of the measuring tube 2 causes an induction voltage in the corresponding coil 13a, 13b via the permanent magnet 12a, 12b. The signals output by the measuring sensor 10 are analog sensor signals that are fed to the measuring channels of the control/evaluation unit 11. Usually, at least one temperature sensor is provided which measures the temperature of the flowing medium F. The temperature sensor is not shown separately in the figures.

FIG. 2 shows a block diagram of an embodiment of a transducer unit 11 of a field device 1 with x measuring channels MKx, which is suitable for carrying out the method according to the invention. The method according to the invention is designed to check the digital measuring channels MKx for their functionality online—i.e. without interrupting the provision of the measured values MW.

From a measuring device 1 not shown and specified separately in FIG. 1, x analog measuring signals Sx are tapped and preprocessed in x associated measuring channels MKx. The number of measuring channels MKx is equal to or greater than two (x≥2). For example, two analog measuring signals S1, S2 are supplied by the vibration sensors 9a, 9b of the Coriolis flowmeter 1 shown in FIG. 1. Usually, an analog temperature measurement signal S3 is also provided by a temperature sensor (not shown separately), which is fed to a third measuring channel MK3.

In each of the measuring channels MKx there is an AD converter, here a sigma-delta converter SDM, which generates a continuous digital data stream Bitstr x from the analog measuring signal Sx. The data stream Bitstr x is passed to a configurable preprocessing block Preproc x. At the output of each of the (individually) configurable preprocessing blocks Preproc x, raw measurement signals or output signals DATA x are made available at equidistant time intervals and are passed on to the microcontroller μC for further processing. The microcontroller μC is part of the control/evaluation unit 11 and continuously determines from the digital raw measurement signals DATA x of the individual measuring channels MKx—usually at defined time intervals or with a cycle rate n—measured values MW that represent the process variable of the medium F to be determined.

According to the invention, in addition to the measuring channels MKx with x=2, 3 . . . , a verification channel VK with a configurable verification block Preproc V is provided.

According to a further embodiment of the invention, a synchronization unit SYNC and a delay unit Delay are assigned to the verification block Preproc V. By means of the verification block Preproc V, it is checked at predetermined or predeterminable time intervals, namely during a predetermined first time period for the first measuring channel MK1 or
during a predetermined first time period for the first measuring channel MK2, whether each of the x preprocessing blocks Preproc x (optionally configured individually or in a manner different from at least one of the other preprocessing blocks Preproc) in the measuring channels MKx is working correctly. For the purpose of (online) checking, the data stream Bitstr x of the measuring channel Mkx (currently) to be verified is switched in parallel to the verification channel VK.

Verification can be carried out, for example, as follows:
The verification block Preproc V is configured in the same way as, for example identically to, the preprocessing block Preproc x to be verified;
the data stream Bitstr x of the measuring channel MKx to be verified is connected in parallel to the input of the verification block Preproc V—in FIG. 2 this is the measuring channel MKx;
The verification block Preproc V is initialized and started using a synchronization function;
The output signals DATA x and DATA V of the measuring channel MKx to be verified and the verification channel VK, which are synchronized, for example, in a cycle-accurate manner, are examined for equality or deviations, wherein a deviation is evaluated as a malfunction of the preprocessing block Preproc x being checked.

Any malfunction detected can be signaled accordingly to the operating personnel of the automation system via the microcontroller μC.

The clock signal Clkx is used to operate the sigma-delta converter SDMx. With each period of the clock signal Clkx, the sigma-delta converter SDMx supplies new data/bits bitstr x to the preprocessing block Preproc x. The Ready signal at the output of the processing block Preproc x only appears every “n” periods of the respective clock signal Clkx. The frequency of the clock signal Clkx and the factor “n” can be the same or different for the measuring channels MKx.

The flowchart shown in FIG. 3 describes the method steps which are carried out according to a further embodiment of the method according to the invention for the (online) checking of one of the measuring channels MKx, e.g., the measuring channel MK2. Incidentally, the individual MKx measuring channels are preferably checked cyclically.

After starting the procedure under point 20, a test is carried out at point 21 to determine whether the predetermined time period or verification interval for checking the previously checked measuring channel MK, e.g., MK1, has expired. This test is carried out successively until the verification interval for checking the previously checked measuring channel MK 1 is completed. As soon as the verification interval of the previously checked measuring channel MK1 has ended, the verification channel VK or the verification block Preproc V at point 22 is configured identically to the measuring channel MK 2 to be checked subsequently. The data stream Bitstr 2 of the measuring channel MK2 to be checked is connected in parallel to the verification channel VK; the output signals DATA 2 of the preprocessing block Preproc 2 and the output signals DATA V of the (verifying) third preprocessing block Preproc V are synchronized and the verification channel MK V is started.

Under point 24, the point at which the verification channel MK V delivers a result DATA V is awaited. In point 25, the output signals DATA 2 of the checked measuring channel MK 2 are compared with the cycle-accurate output signals DATA V of the verification channel MK V in a bit-true manner. If the two output signals DATA 2 and DATA V are identical, the method steps of points 21 to 26 are repeated successively for the measuring channel MKx to be checked next. If a deviation occurs during the checking of one of the measuring channels MKx, the method steps described in points 21 to 26 are repeated at least once. If the check reveals that the deviation is recurring, an error message is generated and displayed at point 28.

FIG. 4 a-g shows a representation of the signal curves for the purpose of cycle-accurate synchronization of the output signals DATA x of the preprocessing block Preproc x currently to be checked in the measuring channel MKx and of the (verifying) third preprocessing block Preproc V in the verification channel MK V.

In FIG. 4a and FIG. 4b it can be seen that the preprocessing block Preproc x to be verified in the measuring channel MKx continuously provides output signals DATA x at a defined time interval n. The cycled provision of the output signals DATA x is signaled to the microcontroller μC by a ready pulse Rdy x (FIG. 4c). The ready pulse Rdy x, which is sent to the control/evaluation unit 11 or to the microcontroller μC, is also shown in FIG. 2.

After the verifying preprocessing block Preproc V is configured identically to the preprocessing block to be checked Preproc x, the synchronization unit Sync receives (see FIG. 2), at any later time, a command pulse k from the control/evaluation unit μC. Subsequently, the synchronization unit Sync waits for the next ready pulse Rdy x of the measuring channel MKx. The corresponding period of waiting or the waiting time is marked with τ (FIG. 4d).

The time period t is random and depends on when the control/evaluation unit or the microcontroller μC sends the command pulse k. In order to be deterministic, the system waits for the next Rdy n pulse and only from this point onwards can τ be calculated.

From the arrival of the next ready pulse Rdy x of the measuring channel MKx, the synchronization unit Sync waits for further time units τ=n−(m mod n). After the waiting time τ=n−(m mod n) has elapsed, the synchronization unit Sync sends a reset pulse Reset V or r to the verification block Preproc V in the verification channel MK V (FIG. 4e, FIG. 3). After the time unit m has elapsed, the verification channel MK V delivers its first synchronized output signal DATA V (FIG. 4f) and a corresponding ready pulse (FIG. 4g). From this point on, the output signals DATA V of the (verifying) third preprocessing block Preproc V and the output signals DATA x of the preprocessing block to be checked Preproc x are synchronized in a cycle-accurate manner. The control/evaluation unit 11 or the microcontroller μC now compares the output signals DATA V of the (verifying) third preprocessing block Preproc V and the output signals DATA x of the preprocessing block Preproc x to be checked in a bit-true manner with regard to possible deviations.

### LIST OF REFERENCE SIGNS

1 field device/measuring device/Coriolis flowmeter
2 measuring tube
3 flange
4 end plate
5 support tube
6 oscillation exciter
7 permanent magnet
8 coil
9 vibration sensors
10 sensor unit/measuring sensor
11 transducer unit
12 permanent magnet
13 coil
14 switching element
MK measuring channel
VK verification channel
SDM sigma-delta converter
Clk clock
Bitstr data stream
Preproc preprocessing block
DATA raw measurement signals/output signals
Sn analog measurement signals
Config configuration block
Rdy/r ready signal
HC microcontroller
Delay delay signal
Start/s start signal
Sync synchronization signal

1-15. (canceled)

16. A method for online checking a field device for determining and/or monitoring at least one process variable of a medium, wherein the field device has a sensor unit and a control/evaluation unit with a first measuring channel formed by a first preprocessing block, a second measuring channel formed by a second preprocessing block, and a verification channel formed by a configurable third preprocessing block, the method comprising:
generating in the sensor unit a first sensor signal dependent on the at least one process variable;
transmitting the first sensor signal to the first measuring channel;
generating in the sensor unit a second sensor signal dependent on the at least one process variable, wherein the second sensor signal is generated simultaneously with the first sensor signal;
transmitting the second sensor signal to the second measuring channel;
converting the first sensor signal in the first measuring channel into a first digitized sensor signal and transmitting the first digitized sensor signal to the first preprocessing block;
converting the second sensor signal in the second measuring channel into a second digitized sensor signal simultaneously with the converting of the first sensor signal;
transmitting the second digitized sensor signal to the second preprocessing block;
configuring the third preprocessing block identically to the first preprocessing block for a predetermined first time period;
transmitting the first digitized sensor signal to the verification channel for the first time period and converting the first digitized sensor signal into a digital output signal of the third preprocessing block that is dependent on the first digitized sensor signal;
synchronizing in a cycle-accurate manner the digital output signal of the third preprocessing block with an output signal of the first preprocessing block and comparing the digital output signal of the third preprocessing block with the output signal of the first preprocessing block in a bit-true manner;
configuring the third preprocessing block identically to the second preprocessing block for a predetermined second time period;
transmitting the second digitized sensor signal to the verification channel for the second time period and converting the second digitized sensor signal into a digital output signal of the third preprocessing block that is dependent on the second digitalized sensor signal; and
synchronizing in a cycle-accurate manner the digital output signal of the third preprocessing block with an output signal of the second preprocessing block and comparing the digital output signal of the third preprocessing block with the output signal of the second preprocessing block in a bit-true manner.

17. The method according to claim 16, further comprising:
generating an error message when the output signals of the first preprocessing block or the output signals of the second preprocessing block and the output signals of the third preprocessing block show a deviation.

18. The method according to claim 16,
wherein the online checking of the two measuring channels is carried out cyclically or acyclically.

19. The method according to claim 16,
wherein, for the purpose of cycle-accurate synchronization of the output signal of the third preprocessing block with the output signal of a preprocessing block to be checked, the following method steps are carried out:
the preprocessing block to be checked continuously provides output signals at a defined time interval and signals a provision of the output signals in each case with a ready pulse;
after the third preprocessing block is configured identically to the preprocessing block to be checked, a synchronization unit of the field device receives a command pulse from a computer at any later time; and
upon receipt of the following ready pulse of the preprocessing block to be checked, the synchronization unit sends a reset pulse to the third preprocessing block after a waiting time, wherein the waiting time is measured such that the output signal of the third preprocessing block and the output signal of the preprocessing block to be checked are synchronized in the cycle-accurate manner.

20. The method according to claim 19,
wherein the waiting time (τ) is determined using the following equation:
$$τ = n - ( m mod n ) ,$$
wherein m indicates a time period known for the preprocessing block to be checked and the third preprocessing block due to the identical calibration.

21. The method according to claim 16,
wherein at least two analog sensor signals are generated by the field device to determine or monitor the at least one process variable of the medium, and the at least two analog sensor signals are digitized and preprocessed in the associated measuring channels.

22. The method according to claim 16,
wherein a mass flow of the medium flowing through a pipeline is determined without interruption based on a phase difference between the first sensor signal and the second sensor signal.

23. The method according to claim 16,
wherein the third preprocessing block is re-configurable.

24. The method according to claim 23,
wherein the third preprocessing block is configured in the same way as the first preprocessing block during the first time period; and/or
wherein the third preprocessing block is configured in the same way as the second preprocessing block during the second time period.

25. The method according to claim 16,
wherein the first preprocessing block is re-configurable; and/or
wherein the second preprocessing block is re-configurable.

26. An automation technology field device, comprising:
a sensor unit;
a control/evaluation unit with a first measuring channel formed by a first preprocessing block, a second measuring channel formed by a second preprocessing block, and a verification channel formed by a configurable third preprocessing block;
a first A/D converter provided in the first measuring channel and a second A/D converter provided in the second measuring channel, wherein each A/D converter is followed by the respective preprocessing block;
a switching element via which digital output signals of the A/D converters can be switched to an input of the third preprocessing block; and
a synchronization unit that is configured to control the third preprocessing block such that an output signal of the third preprocessing block and output signals of the first and second preprocessing blocks are synchronized,
wherein the field device is configured to:
generate in the sensor unit a first sensor signal dependent on the at least one process variable;
transmit the first sensor signal to the first measuring channel;
generate in the sensor unit a second sensor signal dependent on the at least one process variable, wherein the second sensor signal is generated simultaneously with the first sensor signal;
transmit the second sensor signal to the second measuring channel;
convert the first sensor signal in the first measuring channel into a first digitized sensor signal and transmitting the first digitized sensor signal to the first preprocessing block;
convert the second sensor signal in the second measuring channel into a second digitized sensor signal simultaneously with the converting of the first sensor signal;
transmit the second digitized sensor signal to the second preprocessing block;
configure the third preprocessing block identically to the first preprocessing block for a predetermined first time period;
transmit the first digitized sensor signal to the verification channel for the first time period and converting the first digitized sensor signal into a digital output signal of the third preprocessing block that is dependent on the first digitized sensor signal;
synchronize in a cycle-accurate manner the digital output signal of the third preprocessing block with an output signal of the first preprocessing block and compare the digital output signal of the third preprocessing block with the output signal of the first preprocessing block in a bit-true manner;
configure the third preprocessing block identically to the second preprocessing block for a predetermined second time period;
transmit the second digitized sensor signal to the verification channel for the second time period and convert the second digitized sensor signal into a digital output signal of the third preprocessing block that is dependent on the second digitalized sensor signal; and
synchronize in a cycle-accurate manner the digital output signal of the third preprocessing block with an output signal of the second preprocessing block and compare the digital output signal of the third preprocessing block with the output signal of the second preprocessing block in a bit-true manner,
wherein the control/evaluation unit is configured to determine, by comparing the synchronized output signals of the preprocessing block to be checked and the third preprocessing block whether the preprocessing block being checked is operating correctly.

27. The field device according to claim 26,
wherein the measuring channels have identical hardware; and/or
wherein the control/evaluation unit is designed to configure the third preprocessing block identically to the preprocessing block to be checked for the predetermined first or second time period; and/or
the preprocessing blocks of the measuring channels and the third preprocessing block are identical in terms of hardware; and/or
wherein the A/D converters of the first and second measuring channels are each sigma-delta converters.

28. The field device according to claim 27,
wherein the preprocessing blocks are designed such that they provide low-pass filtered digital signals of the analog sensor signals as output signals.

29. The field device according to claim 27,
wherein the preprocessing blocks are designed such that they provide digital signals as output signals that correspond to statistical parameters of the analog sensor signals.

30. The field device according to claim 27,
wherein the preprocessing blocks are designed such that they provide digital signals as output signals that represent components of the analog sensor signals separated by frequencies.
